(19) United States
(12) Patent Application Publication
(10) Pub. No.: US 2020/0232209 A1
(43) Pub. Date: Jul. 23, 2020

(54) Insulated Panel Unit for Building Enveloppe

(71) Applicant: Les Industries Teqnicolor Inc., Quebec (CA)

(72) Inventors: Philippe Trudeau, Quebec (CA); Pierre Petry, Quebec (CA); Richard Germain, Quebec (CA)

(21) Appl. No.: 16/254,044

(22) Filed: Jan. 22, 2019

(30) Foreign Application Priority Data
Jan. 21, 2019 (CA) 3030727

(51) Int. Cl. E04B 1/76; H02S 20/26

(52) U.S. Cl. CPC E04B 1/7608; E04B 1/7625; E04B 2001/742; H02S 20/26; E04B 1/7629

(57) ABSTRACT

An insulated panel unit for connecting with structural elements of a building to at least partially form an envelope of said building is provided. The insulated panel unit includes a front panel adapted to cooperate with the structural elements of the building for positioning and connecting the panel unit in relation therewith, and at least one member having insulating properties secured to the front panel. A building envelope comprising panel units mounted on structural elements of a corresponding building is also provided.

### TECHNICAL FIELD

The technical field generally relates to a building envelope, and more particularly to the panel units forming the building envelope.

### BACKGROUND

A building's envelope is commonly known as the physical separator between the conditioned and unconditioned environment of said building. The envelope can provide resistance to air, water, heat, light, and noise transfer, among others.

Existing systems and methods for forming the envelope of a building includes securing a plurality of panel units to the structure of the building. These panel units include a pan filled with insulating wool sealed therein. The panel unit is then positioned around the building in order to form the envelope. Over time, humidity and condensation can accumulate on the back and within the pan, thus reducing the insulating properties of the panel unit and/or causing the presence of molds.

There is a need for an improved panel unit that can be used for forming an envelope of a building which can be easily manufactured and assembled.

### SUMMARY

According to a first aspect, an insulated panel unit for connecting with structural elements of a building to at least partially form an envelope of the building is provided. The insulated panel unit includes a front panel adapted to cooperate with the structural elements of the building for positioning and connecting the panel unit in relation therewith; and at least one member having insulating properties and being secured to the front panel.

According to a possible embodiment, the at least one member is a composite member having at least one layer of a heat insulating material, or a monolithic member of a heat insulating material.

According to a possible embodiment, the composite member having the at least one layer of the heat insulating material further includes at least one layer of a protective material.

According to a possible embodiment, the at least one member includes side walls, and the front panel includes an outer edge overhanging the corresponding side wall of the member.

According to a possible embodiment, the at least one member includes four side walls, and the front panel includes four outer edges respectively overhanging one of the side walls.

According to a possible embodiment, the insulated panel unit further includes a mounting element secured to the outer edge for connecting the panel unit to the structural element of the building.

According to a possible embodiment, the insulated panel unit further includes a cover member cooperating with the mounting element for at least partially covering the front panel.

According to a possible embodiment, the mounting element includes four mounting elements respectively secured to one of the outer edges.

According to a possible embodiment, each mounting element is further secured to each adjacent mounting element.

According to a possible embodiment, each mounting element has a channel shaped and configured for receiving a corresponding side of the cover member therein.

According to a possible embodiment, the cover member is provided with a display module and/or an energy module.

According to a possible embodiment, the display module is an electronic display module, and wherein the energy module is a solar panel for at least powering the electronic display module.

According to a possible embodiment, the electronic display module is an LED screen.

According to a possible embodiment, the heat insulating material is a high-density heat insulating material.

According to a possible embodiment, the high-density heat insulating material is high-density polystyrene.

According to a possible embodiment, the front panel and the at least one member are secured to one another using an adhesive.

According to a possible embodiment, the front panel, the mounting element and the at least one member are secured to one another using an adhesive.

According to a possible embodiment, the adhesive is a silicone sealant or an adhesive tape.

According to a possible embodiment, the structural elements of the building is a rail system, and the front panel is connected to the rail system via mechanical fasteners.

According to a possible embodiment, the structural elements of the building is a rail system, and wherein the front panel is connected to the rail system via a compression plate.

According to a possible embodiment, the front panel is made of metal, fiberglass, polymeric material or a combination thereof.

According to a second aspect, a building envelope comprising panel units mounted on structural elements of said building is provided. At least one of the panel units is an insulated panel unit as defined above.

According to a third aspect, a use of an insulated panel unit as defined above as part of a building envelope is provided.

### BRIEF DESCRIPTION OF THE DRAWINGS

FIG. 1 is a perspective view of a panel unit according to an embodiment.

FIG. 2 is a sectional view of a panel unit, showing mounting elements and a cover member positioned within the mounting elements.

FIG. 3 is a sectional view of the panel unit shown in FIG. 2, showing the panel unit connected to structural elements of a building, according to an embodiment.

FIG. 4 is a sectional view of a pair of panel units connected to structural elements of a building via a compression assembly, according to an embodiment.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

In addition, although the optional configurations as illustrated in the accompanying drawings comprises various components and although the optional configurations of the panel unit as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperation's therein between, as well as other suitable geometrical configurations may be used for the panel unit, and corresponding parts, as briefly explained and as can be easily inferred here from, without departing from the scope of the disclosure.

As will be explained below in relation to various embodiments, an insulated panel unit connectable to structural elements of a building for at least partially forming an envelope of said building is provided. Briefly described, the panel unit includes a front panel shaped and configured to cooperate with structural elements of a building, such as a rail system for example. The panel unit further includes heat insulating material secured to the front panel in order to form an insulated panel. Components and implementations of the panel unit will become apparent from the following disclosure.

In the following description, an embodiment is to be understood as an example or implementation of the disclosed panel unit. The various appearances of “one embodiment,” “an embodiment” or “some embodiments” do not necessarily all refer to the same embodiments. Although various features of the panel unit may be described in the context of a single embodiment, the features may also be provided separately or in any suitable combination. Conversely, although the panel unit may be described herein in the context of separate embodiments for clarity, the invention may also be implemented in a single embodiment. Reference in the description to “some embodiments”, “an embodiment”, “one embodiment”, or “other embodiments”, means that a particular feature, structure, or characteristic described in connection with the embodiments is included in at least some embodiments, but not necessarily in all embodiments.

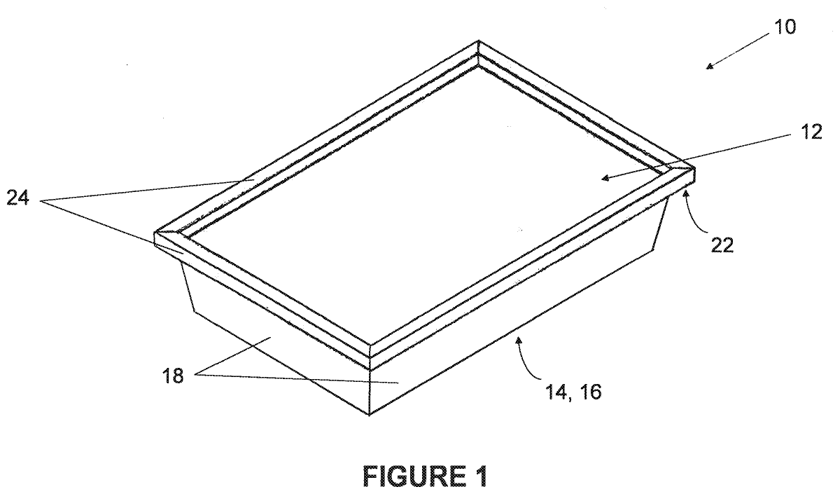

Referring to FIG. 1, an insulated panel unit 10 (hereafter simply “panel unit”) in accordance with an embodiment, is shown. The panel unit 10 is connectable to structural elements of a building in a manner that will be further described below. More specifically, the panel unit 10 is shaped and configured to at least partially form an envelope of the building. It is appreciated that a plurality of panel units 10 can be connected proximate/adjacent one another to form the building envelope. The panel unit 10 includes a front panel 12 and a member 14 having heat insulating properties, said member 14 being secured to a back surface of the front panel 12 for providing insulation to the panel unit 10. In some embodiments, the member 14 is a substantially monolithic member 16 secured to the front panel 12, although it is appreciated that other configurations are possible. For example, the member 14 can be formed of various layers of materials connected to one another and secured to the front panel 12, at least one of said layers having heat insulating properties and optionally at least another of said layers defining a protective layer (e.g. a polymeric film having specific properties such as high resistance to impact, impermeable to at least one of water, water vapor, air, etc.). The monolithic member 16 can be secured to the front panel 12 using an adhesive which is preferably resistant to temperature variations and weathering in order to increase the life-span of the panel unit 10. In this embodiment, the adhesive is silicone sealant (i.e., Silicone Structural Glazing), although it is appreciated that other adhesives and/or fastening methods are possible.

In one embodiment, the member 14 includes a high-density heat insulating material. More specifically, the heat insulating material can be high-density polystyrene adapted to provide a calculated thermal resistance of about R24. As should be readily understood by a person skilled in the art, the «R-value» of the heat insulating material refers to the material's resistance to conductive heat flow. It is appreciated that the R-value of R24 is exemplary, and that other R-values are possible. In some embodiments, the R-value can be calculated in relation to surface area, for example, the member 14 can have a thermal resistance of about R4.2 per square inch (R4.2/in²). It is further appreciated that any other suitable materials can be used to embody the member 14, such as stone wool (i.e., rockwool) for example. Additionally, according to another embodiment, the heat insulating material can be adapted to provide increased water resistance/insulation and/or be fire retardant.

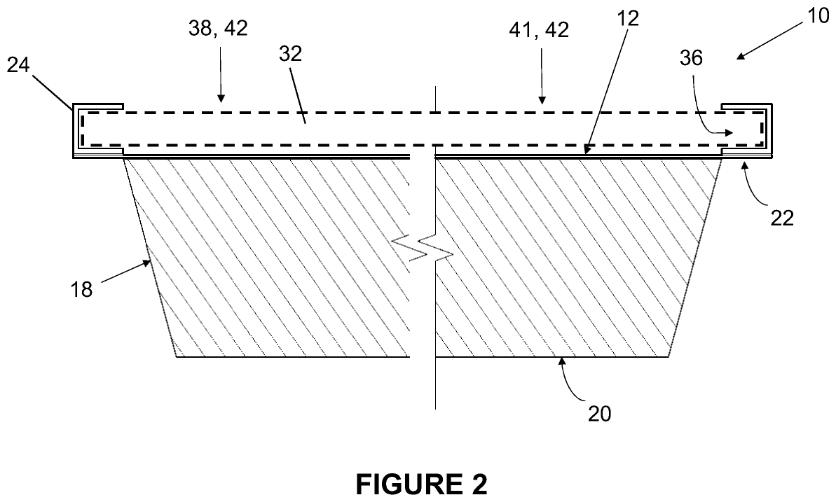

Now referring to FIG. 2, with continued reference to FIG. 1, the monolithic member 16 can be a substantially rectangular or trapezoidal prism having side walls 18 extending from the front panel 12, in addition to having a back wall 20. The side walls 18 can extend substantially transversely from the front panel 12 or at any suitable angle, as seen in FIG. 2. The monolithic member 16 can have any suitable thickness, such as about 30 inches for example, with the back wall 20 being parallel to the front panel 12. However, it is appreciated that other configurations are possible, for example, the monolithic member 16 can have a varying thickness, resulting in the back wall 20 having a slant relative to the front panel 12.

In the illustrated embodiment, the front panel 12 includes one or more outer edges 22 shaped and configured to overhang a corresponding one of the side walls 18 of the monolithic member 16. More specifically, in this embodiment, the front panel 12 is rectangular and therefore has four outer edges 22 respectively overhanging one of the side walls 18. The panel unit 10 can further include mounting elements 24 secured to a front surface of the front panel 12 for connecting the panel unit 10 to the structural elements of the building. In some embodiments, the mounting elements 24 are connected to the outer edges 22 of the front panel 12, although it is appreciated that other configurations are possible. As seen in FIG. 1, the panel unit 10 includes four mounting elements 24 connected to a corresponding one of the four outer edges 22 of the front panel 12. In addition, each mounting element 24 can be connected to the adjacent mounting elements 24 to further secure the assembly of the panel unit 10. In this embodiment, the mounting elements 24 are secured to the front panel 12 and/or connected to one another using a sealing adhesive such as silicone sealant for example. Alternatively, the sealing adhesive can be an adhesive tape suitable for use in buildings and constructions, such as 3M™ VHB™ tape for example.

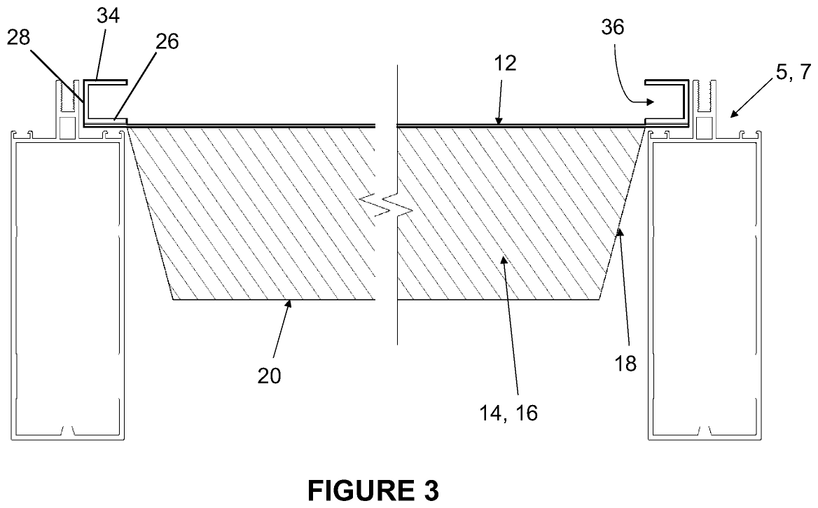

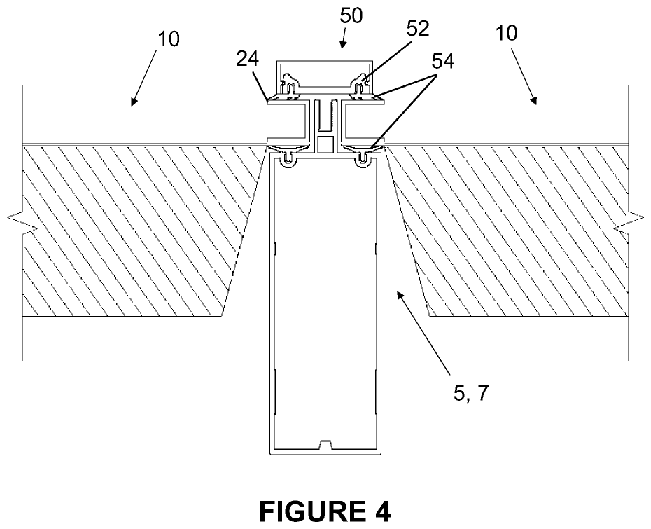

With reference to FIGS. 3 and 4, in addition to FIG. 2, the mounting elements 24 are shaped and configured to cooperate with structural elements 5 of the building, such as a rail system for example. In this embodiment, each mounting element 24 has at least a bottom surface 26 for connecting to the outer edge 22 of the front panel 12, and a rear surface 28 connectable to a rail 7 of the rail system. In some embodiments, the bottom surface 26 and outer edge 22 can also be connected to the rail system of the building. It is appreciated that the mounting elements 24 can be connected to the rail system 7 using any suitable method and/or fasteners, such as structural/mechanical fasteners (e.g., screws) for example. It should be understood that each mounting element 24 can be connected to a corresponding section of the rail system 7 for securing the panel unit 10 thereto, thus forming at least a portion of the envelope of the building.

Referencing more specifically to FIG. 4, the panel unit 10 can be secured to the rail system 7 using a compression assembly 50. In this embodiment, the compression assembly 50 includes a top plate 52 connectable to the rail system 7 and adapted to engage at least one mounting element 24 of the panel unit 10. More Specifically, the top plate 52 is shaped and configured to apply pressure on the corresponding mounting elements 24 in order to further secure said mounting elements 24 in place (i.e., secured to the rail system 7). In some embodiments, the compression assembly 50 can include compressible elements 54 positioned between the panel unit 10 and the top plate 52 and/or rail system 7. The compressible elements 54 are adapted to prevent the panel unit 10 from inadvertently moving by effectively gripping the panel unit 10 under the pressure of the compression assembly 50. In this embodiment, the compressible elements 54 are made of an elastomeric material (e.g., rubber), although it is appreciated that other materials are possible.

In this embodiment, the front panel 12 and mounting elements 24 are made of metal (e.g. a sheet of metal such as an aluminum sheet), although other materials can be used. For example, the front panel 12 and/or the mounting elements 24 can be made of aluminum, fiber glass, a polymeric resin (e.g. PVC), or a combination thereof. It should thus be understood that the front panel 12 and mounting elements 24 can be made of different materials in relation to one another. In some embodiments, the front panel 12 can have a thickness between about 0.032 inches and about 0.080 inches. However, it is appreciated that the front panel 12 can have any other suitable thickness. In addition, the mounting elements 24 can have a similar thickness (i.e., between about 0.032 inches and about 0.080 inches), although it is appreciated that the mounting elements 24 can have a greater thickness than the front panel 12 to increase structural integrity when connecting the mounting elements 24 to the structural elements of the building.

In some embodiments, the panel unit 10 can further include a cover member 32 (FIG. 2) cooperating with the mounting elements 24 and positioned atop the front panel 12 to at least partially cover it. The cover member 32 can be connected to the bottom surface 26 and/or rear surface 28 of the mounting elements 24 to secure the cover member 32 thereto and to the front panel 12. In the present embodiment, each mounting element 24 can further have a top surface 34 opposite the bottom surface 26 for defining a channel 36 therebetween. As best seen in FIGS. 2 and 3, the channels 36 are adapted to face inwardly (i.e., to face the opposite mounting element 24 positioned across the front surface of the front panel 12). As such, it is appreciated that each channel 36 can be shaped and configured to receive a corresponding edge of the cover member 32 therein. It should be understood that the cover member 32 can be connected to the top surface 34 of the mounting elements 24, further securing the cover member 32 in place. In some embodiments, the cover member 32 is positioned within the channels 26 during assembly of the panel unit 10, and prior to connecting the mounting elements 24 to one another.

In this embodiment, each mounting element 24 has a substantially C-shaped cross-section, although it is appreciated that other configurations are possible. It is appreciated that the mounting elements 24 can be formed of a single sheet of material which was simply bent into shape. It should be understood that the mounting elements 24 are bent twice in order to form the C-shaped cross-section. In this embodiment, the bends have a folding radius of about 0.080 inches, although other configurations are possible. Additionally, it is appreciated that the bottom surface 26, rear surface 28 and top surface 34 of the mounting elements 24 can have the same length (e.g., about 7.5 inches) for forming a substantially symmetric C-shape, or different lengths from one another. However, it is appreciated that the different surfaces of the mounting elements 24 can have any other suitable length.

In some embodiments, the cover member 32 can be provided with various modules 38 operatively connected to one another, to other panel units 10 and/or to separate components. More specifically, the modules 38 can include a display module 40 adapted to provide visual information and/or generate images, such as ads for example. The display module 40 is preferably an electronic display module 41, such as an LED screen, adapted to generate images and/or information based on an input signal, although it is appreciated that other configurations are possible. In this embodiment, the modules 38 of the cover member 32 can further include an energy module 42 positioned and configured to provide power to other components, such as the electronic display module 41 for example. The energy module 42 can include a solar panel for gathering sunlight in order to generate power for the display module 40. However, it is appreciated that the energy module 42 can generate power using any other suitable method, such as batteries for example. It is further appreciated that the cover member 32 can simply be a glass panel covering the front panel 12 of the panel unit 10.

It should be understood that, in one embodiment, the panel unit 10 can have a cover member 32 provided with a combination of display and/or energy modules 40, 42 operatively connected to one another. Alternatively, the cover member 32 of a first panel unit 10 can be provided with a display module 40 only, while the cover member 32 of a second panel unit 10 can be provided with an energy module 42 for powering the adjacent first panel unit 10. It is appreciated that other configurations of the modules 38 of the panel unit 10, and cooperation between multiple panel units 10 are possible.

It will be appreciated from the foregoing disclosure that there is provided a panel unit, which includes a single front panel with a member (preferably a monolithic member) of heat insulating material secured thereto. As such, the system can offer substantial improvements over the known prior art in that, in virtue of its design and components, as explained herein, it advantageously enables to a) increase insulation of the building it is installed on, thus reducing costs associated with heating or cooling due to heat transfer through the building envelope (i.e. poor insulation and/or air leakage); b) eliminate, or at least reduce condensation forming on or around the panel unit due to the absence of a housing surrounding the insulating material, simultaneously preventing the formation of mold; c) increase lifetime expectancy of the various components comprising the panel unit; d) provide a panel unit made of renewable/recyclable materials, and many more.

It is to be understood that the phraseology and terminology employed herein are not to be construed as limiting and are for descriptive purposes only. It is to be understood that the details set forth herein do not construe a limitation to an application of the invention. For example, the descriptions, examples, methods and/or materials presented in the claims and the specification are not to be construed as limiting but rather as illustrative only.

What is claimed is:

1. An insulated panel unit for connecting with structural elements of a building to at least partially form an envelope of the building, the insulated panel unit comprising:
a front panel adapted to cooperate with the structural elements of the building for positioning and connecting the panel unit in relation therewith; and
at least one member having insulating properties and being secured to a back surface of the front panel, the at least one member extending rearwardly from the front panel and being configured to remain uncovered by the surrounding structure of the insulated panel unit.

2. The insulated panel unit according to claim 1, wherein the at least one member is selected from the group consisting of a composite member comprising at least one layer of a heat insulating material, and a monolithic member of a heat insulating material.

3. The insulated panel unit according to claim 2, wherein the at least one member is a composite member comprising the at least one layer of the heat insulating material, and the composite member comprising the at least one layer of the heat insulating material further comprises at least one layer of a protective material.

4. The insulated panel unit according to claim 1, wherein the at least one member comprises four side walls, and wherein the front panel comprises four outer edges respectively overhanging one of the side walls.

5. The insulated panel unit according to claim 4, further comprising an elongated mounting element secured to a front surface of the front panel and extending along a length of one of the outer edges, and wherein the elongated mounting element is adapted to be connected to the structural elements of the building via mechanical fasteners or via a compression plate.

6. The insulated panel unit according to claim 5, further comprising a cover member cooperating with the elongated mounting element for at least partially covering the front panel.

7. The insulated panel unit according to claim 6, wherein the elongated mounting element comprises four mounting elements respectively secured to and extending along one of the outer edges.

8. The insulated panel unit according to claim 7, wherein each mounting element is further secured to adjacent mounting elements.

9. The insulated panel unit according to claim 6, wherein each mounting element comprises a channel shaped and configured for receiving a corresponding side of the cover member therein.

10. The insulated panel unit according to claim 6, wherein the cover member is provided with at least one of a display module or an energy module.

11. The insulated panel unit according to claim 10, wherein the cover member is provided with a display module and an energy module, the display module is an electronic display module, and the energy module is a solar panel for at least powering the electronic display module.

12. The insulated panel unit according to claim 11, wherein the electronic display module is an LED screen.

13. The insulated panel unit according to claim 2, wherein the heat insulating material is high-density polystyrene.

14. (canceled)

15. The insulated panel unit according to claim 1, wherein the front panel and the at least one member are secured to one another using an adhesive.

16. The insulated panel unit according to claim 5, wherein the front panel, the elongated mounting element and the at least one member are secured to one another using an adhesive.

17. The insulated panel unit according to claim 15, wherein the adhesive is a silicone sealant or an adhesive tape.

18. (canceled)

19. The insulated panel unit according to claim 1, wherein the front panel is made of metal, fiberglass, polymeric material or a combination thereof.

20. A building envelope comprising panel units mounted on structural elements of a building, wherein at least one of the panel units is an insulated panel unit as defined in claim 1.
